(19) United States
(12) Patent Application Publication
(10) Pub. No.: US 2022/0327477 A1
(43) Pub. Date: Oct. 13, 2022

(54) PARCEL AND FREIGHT SHIPMENT MANAGEMENT SYSTEM AND PROCESS

(71) Applicant: MICHAEL J. HARAKAL, Naples, FL (US)

(72) Inventor: MICHAEL J. HARAKAL, Naples, FL (US)

(21) Appl. No.: 17/225,172

(22) Filed: Apr. 8, 2021

(51) Int. Cl. G06Q 10/08; G06Q 30/02

(52) U.S. Cl. CPC G06Q 10/0834; G06Q 10/0833; G06Q 10/08355; G06Q 30/0282; G06Q 30/016

(57) ABSTRACT

A computer-implemented shipment management process and system for shipping items from a customer to a seller without requiring a customer to expend time and expense of taking an item to a facility includes an App whereby a customer can select an item to be shipped, input information on a shipment, including method and time of pickup of item being shipped, pick up, weighing, boxing, labeling and delivery to a shipment facility, such as USPS, UPS, FedEx, by drivers accepting a shipment request. The system includes customer computer devices, such as smart phone, tablet, laptop or desktop computer connected via Internet to a third party app computer which in turn communicates with a shipment management system computer which oversees the logistics of the shipment and provides information from traffic and. carriers to a pickup driver.

### FIELD OF THE INVENTION

This invention relates to a parcel and transfer management system and more Particularly a process that enables buyers, sellers and retailers to send items to each other without leaving their homes or places of business to complete the shipments.

### BACKGROUND OF THE INVENTION

Recently, and even more so during the COVID-19 pandemic era, customers have been ordering products to be delivered to their homes or businesses from e-commerce retailers instead of shopping at brick and mortar locations for fear of being exposed to the virus. Customers are also purchasing more from shopping ‘marketplaces’ like Amazon/Walmart.com as well as of networks of small sellers like Etsy and peer-to-peer selling platforms such as Poshmark®.

Quite often e-commerce purchases need to be shipped to the seller for a variety of reasons, such as fit/size issues, quality concerns or an incorrect understanding of the product's description of use. In order to ship a product, a buyer must carry out a number of steps, which may include informing the seller, repackaging the product, overboxing the product, weighing, measuring and labeling the product as well as either coordinating a pick up from the specific parcel/freight carrier required or physically transporting the item to a shipping location for the specific carrier of the parcel/freight (e.g., UPS drop box, UPS store or UPS distribution center). Items that exceed parcel carrier dimensions or weights must be shipped by freight carriers. All of the same item details must be selected along with additional details like the type of transport vehicle, such as a liftgate truck and so forth) and additional documentation, such as a Bill of Lading.

This entire process must be replicated for each shipped item, retailer and parcel/freight carrier, making it complex, time consuming and possibly expensive. When shipping from home, boxes on hand may be damaged or inadequate, labels must be printed and affixed to boxes and items that are not small US postal service shipments must be physically brought to carrier-specific shipment locations (e.g., FedEx Office, UPS Store) or carrier-specific pickups must be ordered at added cost, Additionally, carriers will only pick up their own shipments, necessitating the need to have a unique pick up for parcels shipped by a specific carrier.

In view of the above problems, a need exists for a system and process to facilitate boxing, measuring/weighing, labeling, and shipping from a customer's location whereby a single point of contact can facilitate shipments from multiple carrier partners (e.g., FedEx, UPS, USPS, etc.).

### SUMMARY OF THE INVENTION

The primary object of the present invention is to provide a shipment management system and process that may increase the convenience and potentially reduce the cost, time, expense and risk of disease exposure incurred by the shipper.

Another object of the present invention is to provide such a system and process that eliminates the need for a shipper to leave a home or business to ship an item. The present invention accomplishes the above and other objects by providing a computer-implemented shipment management system and process wherein a customer initiates a shipment on an electronic device. Customers may link the invention software to the software of other platforms or retailers to make future shipments easier and faster such as purchase history and sales history, or the information may be entered manually by another party, such as a. shipper or driver. In either case, item details must be entered, including, but not limited to, the description, dimensions, weight, value, origin and destination locations.

This invention proposes using a fleet of carrier-agnostic, independent contractor drivers to replace the captive parcel/freight carrier pick drivers to pick up shipments from customers and transport them to the carriers' shipping locations. In addition, this location-agnostic, shipper-agnostic, seller-agnostic and carrier-agnostic platform allows customers to complete shipments without having to expend the time, expense and complexity currently associated with sending items between parties.

Depending on the retailer, recipient or platform, shippers may or may not be responsible for the cost of the shipment. In cases where an item is already boxed with a prepaid label, it is possible that the use of the system may he solely to route a driver to the customer for parcel pick up and handling.

In other cases, customers may indicate the materials needed (or not needed) for the shipment, including boxes, labels, and packaging materials. If some of this information is unknown, the shipper can request the driver measure, weigh and/or box the item at the time and location of pick up as well as quote shipping and print a shipping label from multiple carriers. The invention will offer negotiated shipping rates with parcel/freight carriers to ensure a good value for purchasing the shipment through the app. Additional parcel options, such as insurance, expedited pick up, etc. may also be available at added cost.

Once a shipment order is submitted, the order is analyzed by a proprietary algorithm to determine the optimal driver routing and assignment, Item pick up and drop off routes are optimized based on actual or projected driver factors (e.g., mileage, traffic, driver location, driver cargo capacity, etc.) during the pick up window. Drivers are routed based on the information inputted by a customer to nearby drivers who can accept and handle the shipment of the item. If a driver is unavailable for a pick up in a reasonable time, the system may create a pick up order with the carrier itself to ensure business continuity and adequate service levels for shippers.

Contracted drivers will act as carrier-independent couriers of the parcel shipments and will facilitate transportation between the customer's pick up address and the carrier's drop off location. Shipping customers will have a choice of service levels with faster pick up times, shorter pick up windows, more remote locations or longer/higher traffic pick up trips generally being more expensive. For large or bulky items, such as furniture, pick up orders may be routed to or through freight shipping partners or partner websites, such as Uship®, to facilitate the handling and transfer of such items.

The shipper will receive event-driven notifications regarding their shipment order status, driver location and parcel/freight shipment status. The invention will have the ability to connect to parcel/freight shippers to gather and display the current shipment location and status.

If the shipper has integrated and linked retail shopping apps to the invention and an order history can be automatically imported to the invention, the invention may have the capability to display retailer shipment policies and/or alert customers that they have purchases nearing the end of their eligible shipment period. It may also check to see if a previous order/item is still eligible for shipment and notify a customer that an order/item has passed the eligible shipment period. Finally, the invention may notify customers regarding the retailer's shipment status, for example, Approved, Pending, Accepted, Rejected, Completed, Credited and so on.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1A is a flow diagram of the process for shipments management of the present invention described herein;

FIG. 1B is a flow diagram of the process for shipments management of the present invention described herein; and

FIG. 2 illustrates one example of the architecture of the computer network to carry out the shipment management system and process of the present invention described herein.

### DESCRIPTION OF THE PREFERRED EMBODIMENTS

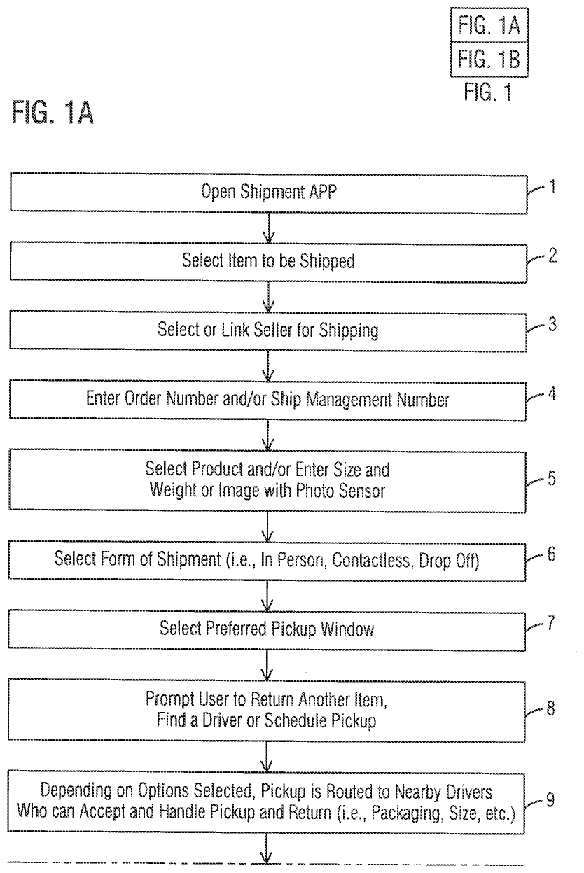

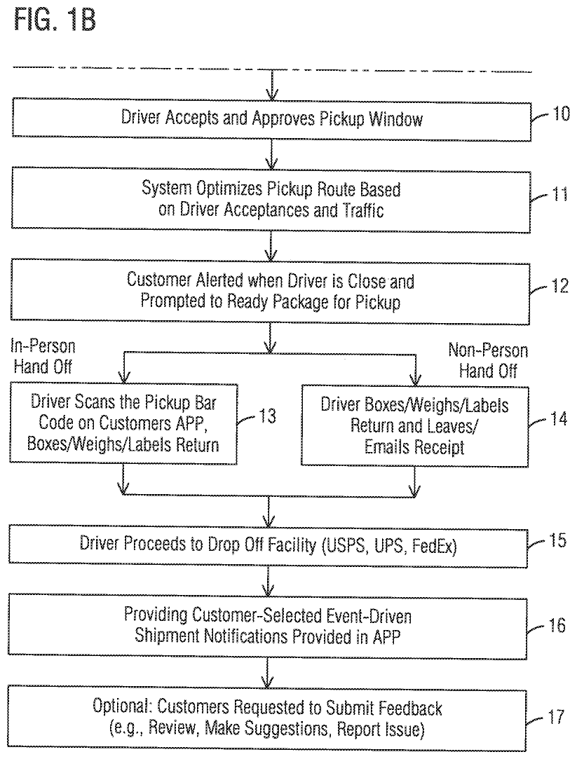

Discussing the process of the shipment management system of the present invention, reference is made to the flow diagram of FIGS. 1A and 1B, The process begins with a customer opening his or her App 1 on a device, such as a smart phone, tablet, laptop or desktop computer registering for the service which will allow the customer to set up a user ID and password. A customer's pickup region will be established based on zip code and if the customer is located in a non-supported region they will be notified that the service is not available or that the request might possible be routed directly to a carrier.

Once in the app, if products purchased are already integrated in the App, the App may show under a heading “Ship a Recent Purchase” a list of recent orders from a linked store 2. If the vendor system provides a shipment document or shipping label then the customer will only need to enter the vendor, shipment location and a tracking # or shipment ID,

If not integrated or shown, a prompt appears to link a new store (or to skip for manual shipment) or to select or link a new store. Once a store is selected, a link or login can connect the customer to the store 3. An order number and/or a Shipment Management Number can be entered 4.

The customer then selects the product or products to be shipped 5 and if not already in the database enters the dimensions and weight (or uses a photo sensor or camera on the customer's device to determine approximate size), which is pertinent to the cost of the shipment and the packaging needed by a driver selected to pick up the shipment. The customer then selects the form of shipment 6, that is, whether the shipment be in-person, contactless or drop off. Immediately following the latter selection, the customer selects a preferred pick up window 7. Generally the narrower the pickup window the higher the cost for the pick up. Just case a customer has multiple shipments, the customer is prompted 8 by the App to repeat the latter process 7 to select another item for shipment, find a driver and schedule a pick up window.

Depending on the options selected in the latter steps, a pick up or pickups get routed to nearby drivers 9 who can accept the pick up and have the ability to facilitate the shipment according to various factors, such as vehicle size, box size inventory and so forth. Once a pickup is accepted by a driver 10, the shipments system optimizes the pick up route for the driver based on other pickups the driver has already accepted and current traffic (or projected traffic during the pick up window) using WAZE®, Google® or some other available traffic mapping platform 11.

Customer pickup locations are regionalized and drivers will poll the system for pickup requests in their predefined region. Drivers will be given the ability to request up to 10 pickups in a region during a single work request. The limit is to insure that drivers adhere to pickup windows and do not simply bulk accept pickups to limit other drivers.

A customer can be automatically alerted when the driver is close and prompted to get the product to be shipped ready for pick up 12. Once the driver arrives, in case of an in-person pick up 13 the driver may scan a bar code on the customer's smartphone App, box, weigh and label the shipment and provide a receipt to the customer. In case of a non-person hand off when the customer is not present, such as at work, the driver performs the same tasks, but leaves or emails a pick up receipt.

In some cases for security reasons, particularly in cities and communities where non-residents are not allowed entry, items to be shipped may be place in secured lockers for pickup by a driver who would be provided an entry code by a customer.

Next, the driver proceeds to a drop off facility 15, which could be a UPS store, FedEx office, USPS facility or other carrier. From the time of shipment pick up to its shipment to the seller, the package it tracked and notifications are provided to the customer based on preselected events by the customer, such as, when the shipment is dropped off at the shipping location and updated daily through delivery completion. Such status can be tracked via Shipstation's integrations to USPS, FedEx or UPS to the App on a customer's smartphone 16. The customer has a shipment dashboard in the App that includes such items as total shipments (combination of initiated, picked up, in transit delivered and completion of shipments as well as exception., average shipments per week/month/year, average transit time, average shipment value total quantity shipments by retailer and total value of shipments by retailer. Moreover, at any time a customer can call a parcel carrier customer service within the App to track progress of the shipment. The App also has easy links to a “File a Claim” section of carriers' sites.

A final optional step in the process 17 is a prompt by the App to submit feedback, such as a review, suggested improvements or to report an issue, such as to report items not being picked up or damaged during pick up and so forth.

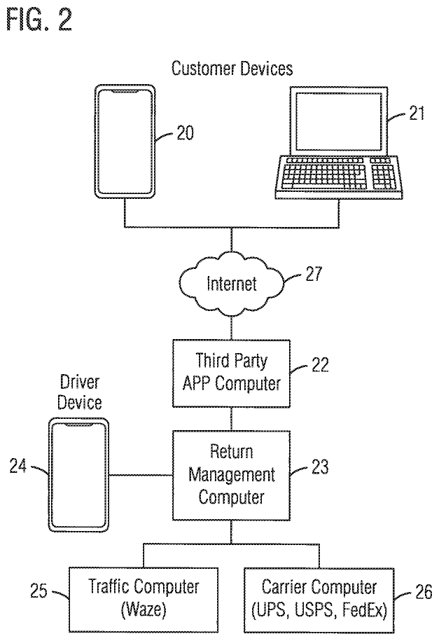

Referring now to FIG. 2, an example of a computer network to carry out the shipment management system and process is illustrated. The process begins with a customer device, such as a smartphone 20, desktop 21 or other electronic device, such as a tablet or laptop onto which has been downloaded the shipment system App or website and which is connected to the Internet 27 or mobile carrier, A third party App computer 22 connects the customer to a shipment management system computer 23 through a customer portal whereby the customer posts pickup requests. The pickup requests are then made available to drivers who request those pickups and the pickups are assigned to them. The driver's device may be a smartphone, tablet or laptop which is also connected to the shipment management system computer 23. When a driver receives and accepts a pick up request from a customer simultaneous with notification to the shipment management system computer 23, the shipment management system computer 23 obtains optimal traffic information from a traffic platform App, such as Waze, and information from nearby carriers, such as UPS, USPS or FedEx and provides same to the driver.

It is to be understood that while a preferred embodiment of the invention is described, it is not to be limited to the specific form or arrangement of parts herein described and shown. It will be apparent to those skilled in the art that various changes may be made without departing from the scope of the invention and the invention s not to be considered limited to what is shown and described in the specification and/or drawings.

I claim:

1. A computer-implemented shipments management process comprising:
a customer inputting information about an item to be shipped on an device wherein the step of inputting the information involves selecting a recent purchase for shipment, selecting a seller to which the item is to be shipped, entering a shipment order number, inputting size and weight of the item to be shipped if necessary, selecting a form of shipment, selecting a preferred pick up window and repeating the step of inputting information for additional items to be shipped;
routing a shipment request based on the information inputted by a customer to a shipment management system computer;
a driver who can accept and handle the shipment request viewing, accepting and being assigned the request of the item and approving the pick up window;
optimizing a pick up route of the shipment of the item based on driver factors and current and projected traffic during the pick up window;
alerting the customer when the driver is nearby to prepare the shipment item to be picked up;
the driver preparing the shipment item for shipment, including boxing, weighing and labeling the shipment item as necessary;
the driver proceeding to drop off the shipment item at a delivery carrier; and
providing customer-selected event-driven shipment notifications.

2. The computer-implemented shipments management process of claim 1 further comprising the step of:
requesting a customer to submit feedback on the shipment process for a specific item.

3. The computer-implemented shipments management process of claim 1 wherein the step of whether a driver can accept an item for shipment is determined by various factors from a group of factors including location, other pick ups previously accepted, size and available packaging.

4. The computer-implemented shipments management process of claim 1 wherein the step of optimizing a pick up route based on traffic is performed by using computerized traffic Apps from a group including Waze and Google.

5. The computer-implemented shipments management process of claim 1 wherein the step of the driver dropping of the pick up at a drop off facility includes facilities from a group including USPS, UPS and FedEx.

6. The computer-implemented shipments management process of claim 1 wherein the step of the driver picking up the shipment item at a customer pick up location includes obtaining the shipment item from a secure locker in which a customer has placed the shipment item for pick up. The computer-implemented shipments management process of claim 1 wherein the step of customer-selected shipment alert notifications includes event from a group including when the item is dropped off at a shipping facility, when a first tracking change occurs and when the shipment item is received by a seller.

8. The computer-implemented shipments management process of claim 1 further comprising:
the customer accessing a shipment dashboard that includes information from a group including total number of shipments, average shipments per period, average transit time, average shipment value, total quantity of shipments by seller and total value of shipments by seller.

9. A computer-implemented shipments management system comprising:
customer inputted information about an item to be shipped on an device wherein the step of inputting the information involves selecting a recent purchase for shipment, selecting a seller to which the item is to be shipped, entering a shipment order number, inputting size and weight of the item to be shipped if necessary, selecting a form of shipment, selecting a preferred pick up window and repeating the step of inputting information for additional items to be shipped;
a shipment request based on the information inputted by a customer routed to a shipment management system computer;
a driver who can accept and handle the shipment request viewing, accepting and being assigned the request of the item and approving the pick up window;
an optimized a pick up route of the shipment of the item based on driver factors and current and projected traffic during the pick up window;
a customer alert when the driver is nearby to prepare the shipment o be picked up;
the driver preparing the shipment item for shipment, including boxing, weighing and labeling the shipment item as necessary;
the driver proceeding to drop off the shipment item at a delivery carrier; and
customer-selected event-driven shipment notifications.

10. The computer-implemented shipments management system of claim 9 further comprising:
a request for a customer to submit feedback on the shipment process for a specific item.

11. The computer-implemented shipments management system of claim 9 wherein whether a driver can accept an item for shipment is determined by various factors from a group of factors including location, other pick ups previously accepted, size and available packaging.

12. The computer-implemented shipments management system of claim 9 wherein optimizing a pick up route based on traffic is performed by using computerized traffic Apps from a group including Waze and Google.

13. The computer-implemented shipments management system of claim 9 wherein the driver drops off the pick up at a drop off facility includes facilities from a group including USPS, UPS and FedEx.

14. The computer-implemented shipments management system of claim 9 wherein the driver picks up the shipment item at a customer pick up location includes obtaining the shipment item from a secure locker in which a customer has placed the shipment item for pick up.

15. The computer-implemented shipments management system of claim 9 wherein the customer-selected shipment alert notifications includes events from a group including when the item is dropped off at a shipping facility, when a first tracking change occurs and when the shipment item is received by a seller.

16. The computer-implemented shipments management system of claim 9 further comprising:
the customer accessing a shipment dashboard that includes information from a group including total number of shipments, average shipments per period, average transit time, average shipment value, total quantity of shipments by seller and total value of shipments by seller.
